(19) United States
(12) Patent Application Publication
(10) Pub. No.: US 2014/0367452 A1
(43) Pub. Date: Dec. 18, 2014

(54) METHOD OF FRICTION STIR WELDING

(71) Applicant: FOCUS: HOPE, Detroit, MI (US)

(72) Inventors: Guru P. Dinda, Troy, MI (US); Michael D. Gray, Detroit, MI (US); Richard E. Miller, Howell, MI (US)

(21) Appl. No.: 14/308,352

(22) Filed: Jun. 18, 2014

Related U.S. Application Data
(60) Provisional application No. 61/836,320, filed on Jun. 18, 2013.

(51) Int. Cl. B23K 20/12

(52) U.S. Cl. CPC B23K 20/1225
USPC 228/112.1

(57) ABSTRACT

A method of friction stir welding is provided. The method includes providing a stir tool configured to rotate about and move along a stir tool axis and includes a pin with a pin axial end surface and a pin tapered surface that extends radially outwardly from the pin axial end surface. The method further includes providing the first member with a first member faying surface and defining a normal line that is normal to the first member top surface, is perpendicular to a longitudinal axis, and extends through a reference point. The method further includes providing the second member with a second member faying surface and forming a joint interface between the first and second members. The method further comprises contacting the rotating pin with the second member faying surface, the stir tool axis being disposed at a side tilt angle upon contact.

### CROSS-REFERENCE TO RELATED APPLICATION

This application claims the benefit of U.S. provisional application No. 61/836,320, filed Jun. 18, 2013, which is hereby incorporated by reference as though fully set forth herein.

### STATEMENT REGARDING FEDERALLY SPONSORED RESEARCH & DEVELOPMENT

This invention was made with government support under Contract No. W56 HZV-05-C-0721 awarded by the U.S. Army Tank Automotive Research, Development, and Engineering Center. The government has certain rights in the invention.

### BACKGROUND

a. Technical Field

The field of the present disclosure generally relates to a method of friction stir welding. In particular, this disclosure relates to a method of friction stir welding whereby various angles of the components involved correspond to one another and whereby heat is selectively removed from one of the workpieces to form a stronger weld joint.

b. Background Art

This background description is set forth below for the purpose of providing context only. Therefore, any aspects of this background description, to the extent that it does not otherwise qualify as prior art, is neither expressly nor impliedly admitted as prior art against the instant disclosure.

Traditional heat-welding melts and re-solidifies materials to bond them together. This process can significantly reduce the strength of the weld joint material. Furthermore, the strength of a fusion weld joint between dissimilar materials, particularly metal alloys, is further compromised because of inherent chemical reactions which occur between differing material compounds when heated above or near melting temperatures.

Friction stir welding is capable of successfully joining dissimilar alloys which could not be welded using traditional melt-welding techniques. This is because the joint materials are only softened and not melted, which avoids the effects of the harmful chemical reactions in melt-welding. Friction stir welding is an energy-efficient, environmentally friendly, and versatile solid-state joining process. Friction stir welding allows for the joining of alloy parts by use of a specially designed rotating tool that is moved along the joint interface of the parts creating frictional heat, which warms the local materials to a softened state of plasticity where they can be easily deformed. Thus, the materials are stirred together by the action of the rotating tool. This process may create weld joint produced totally in a solid, non-liquid state and avoids the adverse chemical and metallurgical microstructure changes associated with melt welding.

During the friction stir welding process, the adjoining parts are placed against each other, and the rotating tool is slowly plunged into the joint interface between the two parts. Once the rotating tool is fully inserted and the local material(s) have reached an adequate temperature, the rotating tool is then moved along the joint interface to stir the material(s) into a single solid assembly.

Friction stir welding can be applied to various types of joints, the most common being butt joints and lap joints. To create a butt joint using friction stir welding, the ends of the component parts may be precisely aligned side-by-side, forming a relatively vertical seam or joint interface. Extra care may be required with butt welding to ensure the materials do not separate during the process because the initial plunge of the apparatus into the joint line may cause the materials to move. Lap welding is performed by overlapping a section of one of the parts with a section of the other part, and clamping them together. The rotating tool is fully inserted through one of the parts at the location of the overlapped portion with the pin end of the tool partially protruding into the opposing part.

With respect to butt welding, the rotating tool may be tilted backwards at a back tilt angle to affect the plastic deformation, flow, displacement of the joint material(s), forces exerted onto the joint materials, and frictional heating caused by the rotating tool. However, when the rotating tool is tilted in such a manner with only a back tilt (and lacking a side tilt), the rotating tool and the joint interface are no longer aligned and/or parallel. This misalignment results in less than optimum contact between the rotating tool and the joint materials and may result in greater tool wear.

Metal alloys have different solidus (melting) temperatures which affect the material selection for friction stir weld joints. Dissimilar alloys of the same base metal (e.g. aluminum) have different chemical compounds based on the constituents added to the base metal but have similar solidus temperatures. However dissimilar alloys from different base metals (e.g. aluminum and steel) have vastly different solidus temperatures. Since a major advantage of the friction stir welding process is the avoidance of melting temperatures during the joining process, acceptable quality friction stir welding joints between parts made from dissimilar metal alloys is difficult because the elevated material temperature required to reach plasticity in one of the alloys may exceed the solidus temperature of the other alloy. It may be undesirable to allow the metal alloy with the lower solidus temperature to liquefy.

Thus, there is a need for a method of joining dissimilar materials using a friction stir process that will minimize and/or eliminate one or more of the above-identified deficiencies.

The foregoing discussion is intended only to illustrate the present field and should not be taken as a disavowal of claim scope.

### SUMMARY

This disclosure relates to a method of friction stir welding. In particular, this disclosure relates to a friction stir process using an angled joint interface between members to be joined that corresponds to a pin angle and removing heat from one of the members.

The method described herein results in optimum contact between the stir tool and the joint interface and/or the faying surface of the harder material, resulting in a stronger weld joint with improved metallurgical bonding. Moreover, by utilizing the method described herein, the stir tool may experience less wear.

A method of friction stir welding a first member and a second member to form a friction stir weld joint therebetween in accordance with one embodiment of the present teachings comprises providing a stir tool configured to rotate about and move along a stir tool axis and comprising a pin with a pin axial end surface and a pin tapered surface that extends radially outwardly from the pin axial end surface. The method further comprises providing the first member, the first member comprising a first member faying surface, the first member further defining a normal line that is normal to the first member top surface, is perpendicular to a longitudinal axis extending through the first member, and extends through a reference point. The method further comprises providing the second member, the second member comprising a second member faying surface. The method further comprises forming a first joint interface between the first member and the second member by abutting at least a portion of the first member faying surface with at least a portion of the second member faying surface. The method further comprises rotating the pin of the stir tool. The method further comprises contacting the rotating pin of the stir tool with the second member faying surface, the stir tool axis being disposed at a side tilt angle upon contact, and the side tilt angle being measured by rotating the stir tool axis about the longitudinal axis from a position parallel to the normal line. The stir tool plasticizes the first member and the second member proximate to the first joint interface thereby forming the friction weld joint.

A method of friction stir welding a first member and a second member to form a friction stir weld joint therebetween in accordance with one embodiment of the present teachings comprises providing a stir tool configured to rotate about and move along a stir tool axis and comprising a pin with a pin axial end surface and a pin tapered surface that extends radially outwardly at a pin angle from the pin axial end surface, the pin angle being measured from the stir tool axis. The method further comprises providing the first member, the first member comprising first member faying surface. The method further comprises providing the second member, the second member comprising a second member top surface and a second member faying surface extending therefrom. The method further comprises forming a joint interface between the first member and the second member by abutting at least a portion of the first member faying surface with at least a portion of the second member faying surface, the joint interface being disposed at a joint interface angle measured from a line normal to the second member top surface. The method further comprises rotating the pin of the stir tool. The method further comprises contacting the rotating pin of the stir tool with the second member faying surface. The pin angle of the stir tool and the joint interface angle are approximately equal, and the stir tool plasticizes the first member and the second member proximate to the joint interface thereby forming the friction weld joint.

A method of friction stir welding a first member and a second member to form a friction stir weld joint therebetween in accordance with one embodiment of the present teachings comprises providing a stir tool configured to rotate about a stir tool axis and comprising a pin. The method further comprises providing the first member comprising a first member faying surface. The method further comprises providing the second member comprising a second member faying surface. The method further comprises forming a joint interface between the first and second members by positioning the first and second members such that at least a portion of the first member faying surface abuts at least a portion of the second member faying surface. The method further comprises rotating the pin of the stir tool. The method further comprises moving the rotating pin of the stir tool across the joint interface. The method further comprises removing heat from the first member. The stir tool plasticizes and joins the first member and the second member proximate to the joint interface.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a schematic cross-sectional view illustrating a friction stir tool mounted to a machine tool holder.

FIG. 2A is an isometric view of two members brought together to form a joint interface therebetween in accordance with an embodiment of the present teachings.

FIG. 2B is an exploded isometric view of the members of FIG. 2A.

FIG. 3 is an isometric view illustrating the stir tool of FIG. 1 in alignment with the members of FIGS. 2A-2B in accordance with another embodiment of the present teachings.

FIG. 4 is a right-side view of the stir tool and members of FIG. 3 illustrating a back tilt angle of stir tool.

FIG. 5 is a front view of the stir tool and member of FIG. 3 illustrating a side tilt angle of stir tool.

FIG. 6A is a close-up schematic view showing the alignment of the friction stir tool of FIG. 1 relative to the member of FIGS. 2A-2B when the friction stir tool is in a vertical position.

FIG. 6B is a close-up schematic view showing the alignment of the friction stir tool of FIG. 1 relative to the member of FIGS. 2A-2B when the stir tool is in a back-tilted position.

FIG. 6C is a close-up schematic view showing the alignment of the friction stir tool of FIG. 1 relative to the member of FIGS. 2A-2B when the stir tool is in a side- and back-tilted position.

FIG. 7 is a schematic front view illustrating the stir tool of FIG. 1 in a plunge position relative to the members of FIGS. 2A-2B.

FIG. 8 is a schematic isometric view illustrating the stir tool of FIG. 1 as it travels along the joint interface of FIGS. 2A-2B.

FIG. 9A is an isometric view of two members brought together to form a joint interface therebetween in accordance with another embodiment of the present teachings.

FIG. 9B is an exploded isometric view of the members of FIG. 9A.

FIG. 10 is a schematic isometric view illustrating the stir tool of FIG. 1 forming a first weld joint along the joint interface of FIGS. 9A-9B.

FIG. 11 is a schematic isometric view illustrating the stir tool of FIG. 1 in a plunge position relative to the members of FIGS. 9A-9B as it begins to form a second weld joint.

FIG. 12 is a schematic isometric view of cooling members in contact with the one of the members of FIGS. 2A-2B in accordance with another embodiment of the present teachings.

FIG. 13 is a flowchart diagram of a method for friction stir welding the members of FIGS. 2A-2B using the friction stir tool of FIG. 1 in accordance with another embodiment of the present teachings.

FIG. 14 is a flowchart diagram of a method for friction stir welding the members of FIGS. 9A-9B using the friction stir tool of FIG. 1 in accordance with another embodiment of the present teachings.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It will be appreciated that for conciseness and clarity, spatial terms such as “vertical,” “horizontal,” “up,” and “down” may be used herein with respect to the illustrated embodiments. However, friction stir welding tools may be used in many orientations and positions, and these terms are not intended to be limiting or absolute.

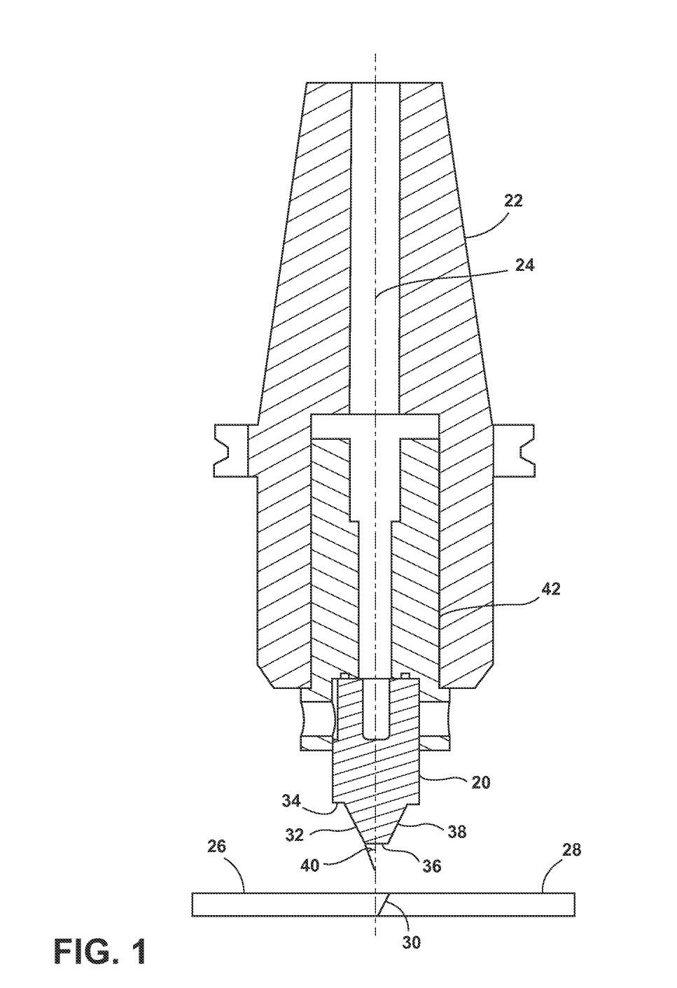

Referring now to the drawings wherein like reference numerals are used to identify identical or similar components in the various views, FIG. 1 is a schematic cross-sectional view illustrating a friction stir tool 20 mounted to a machine tool holder 22 (and perhaps tool adaptor 42). In an embodiment, stir tool 20 is configured to rotate about and move along a stir tool axis 24 and to join members 26, 28 together at a joint interface 30 therebetween by warming the members 26, 28 (via friction effected by rotational contact of stir tool 20) and mixing the softened members 26, 28 at the joint interface 30. In some embodiments, stir tool 20 may comprise a pin 32 and a shoulder 34. In other embodiments, stir tool 20 may comprise a pin only with no shoulder. Pin 32 may be configured to rotate about axis 24 and to plunge and/or be inserted into members 26, 28 proximate to joint interface 30. In an embodiment, pin 32 may comprise a pin axial end surface 36 and a pin tapered surface 38 that extends radially outwardly from pin axial end surface 36 to shoulder 34 at a pin angle 40 (relative to stir tool axis 24). Pin axial end surface 36 may make initial contact with member(s) 26, 28. The tapering of pin 32 allows for greater surface area as the pin 32 plunges further into members 26, 28, thereby, increasing the friction and heat produced. Additional advantages of a tapered pin 32 are known in the art (e.g., ability to be repeatedly dressed via machine grinding); however, the pin may incorporate one or more other geometric shapes and features in accordance with the present teachings, including but not limited to cylindrical, cuboid, prism, conical, and eccentrics. In the illustrated embodiment, pin axial end surface 36 and pin tapered surface 38 are planar; however, one of ordinary skill in the art will understand that surfaces 36, 38 may include protrusions and geometric features such as, not limited to, threads, scrolls, or flutes. To withstand the frictional heat generated, stir tool 20 (or merely pin 32 and shoulder 34) may be made from a material which has a solidus or melting temperature greater than that of the materials of members 26, 28. In an embodiment, stir tool 20 (or pin 32 and shoulder 34) may be made from a tungsten-based material, such as W-25% Re alloy, or other refractory metal alloys. In another embodiment, pin 32 may be made from cubic boron nitride synthetics.

With continued reference to FIG. 1, tool holder 22 may be coupled to a machine (not shown) and adapted to rotate about axis 24 and tilt or angle axis 24 in various directions other than vertical. In an embodiment, the machine may be a multi-axis computer numerically controlled (CNC) machine, such as the GG1 Series Friction Stir Machine from Transformation Technologies Inc. In the illustrated embodiment, tool holder 22 is coupled to stir tool 20 via a tool adaptor 42, which may or may not be required depending on tool holder 22 required for the specific machine and the design of stir tool 20.

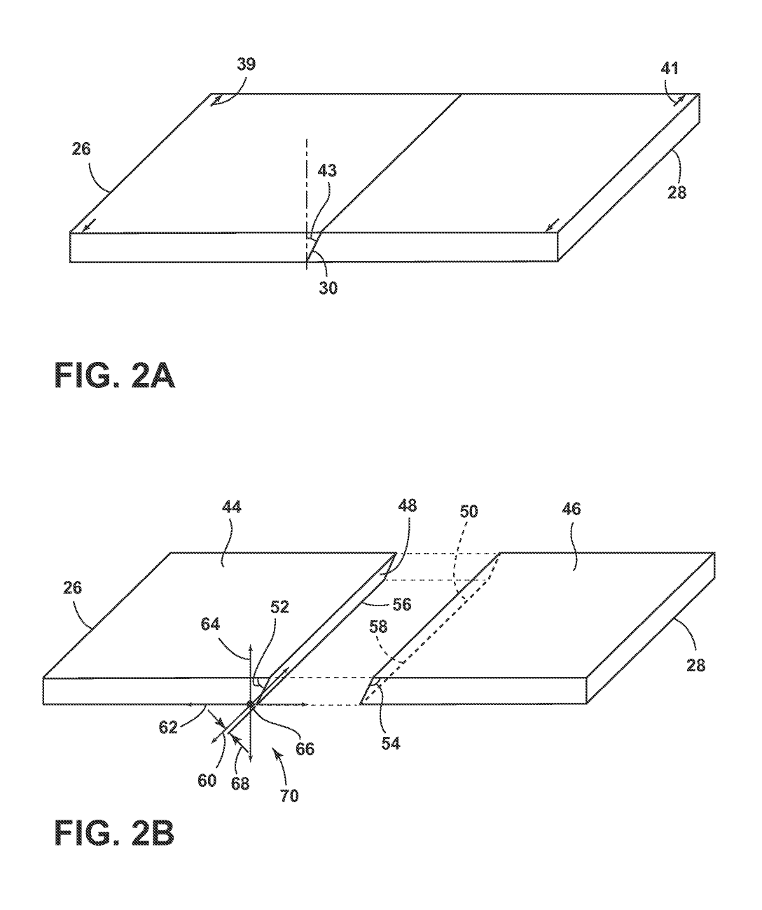

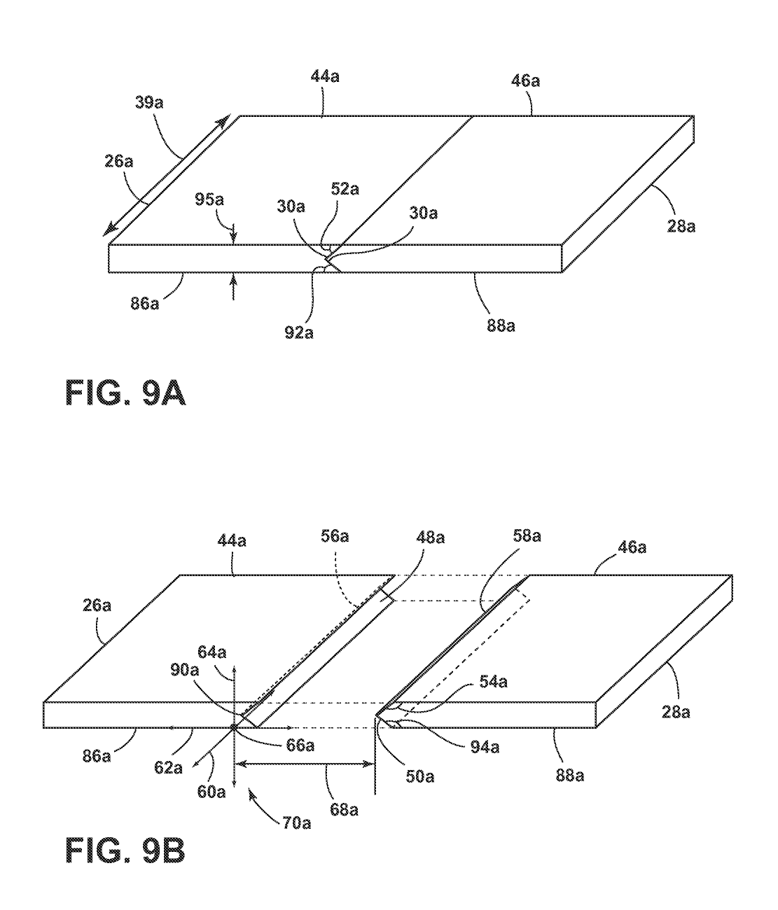

FIG. 2A is an isometric view of members 26, 28 brought together to form joint interface 30 therebetween in accordance with an embodiment of the present teachings. FIG. 2B is an exploded isometric view of members 26, 28 of FIG. 2A. As discussed generally hereinabove, members 26, 28 can be brought together to form joint interface 30, which is the area in which members 26, 28 contact each other (prior to contact with stir tool 20). Stir tool 20 (FIG. 1) travels along joint interface 30, thus, stirring and joining portions of members 26, 28 that have been softened due to the friction-induced heat to form a friction weld joint. In the illustrated embodiment, joint interface 30 is angled at a joint interface angle 43. Such angling may be desirable so that it corresponds with pin angle 40 (FIG. 1), as will be described in more detail hereinbelow. Members 26, 28 may each have a length 39, 41, a top surface 44, 46 and a faying surface 48, 50 extending at an angle 52, 54 from their respective top surfaces 44, 46 to an edge 56, 58, respectively. In one embodiment, angle 52 of member 26 may be less than ninety degrees measured between top surface 44 and faying surface 48, whereas, angle 54 of member 28 may be greater than ninety degrees measured between top surface 46 and faying surface 50. In the illustrated embodiment, top surfaces 44, 46 are generally planar relative to one another and that the sum of angles 52, 54 is approximately one hundred eighty degrees. One of ordinary skill in the art will understand, however, that joint interface 30 can take on a variety of configurations other than that illustrated. For example, angles 52, 54 may each be approximately ninety degrees, thus, forming a vertical (rather than angled) joint interface. Moreover, joint interface may lie in one plane or more than one plane. For example, joint interface may be V-shaped along its cross-section (as shown hereinbelow in FIGS. 9A-9B). In the illustrated embodiment, member 26 and member 28 are generally rectangular in shape. However, one of ordinary skill in the art will understand that members can be a variety of shapes such as, for example and without limitation, cylindrical and/or tubular. Members may also be non-uniform in shape. In some embodiments, members 26, 28 are metal. In one particular embodiment, members 26, 28 are made from dissimilar metals or metal alloys such as, for example and without limitation, aluminum and steel, respectively. Other examples of harder alloys are titanium, nickel, and cobalt. Preferably, member 26 is composed of a softer material(s) with a lower solidus temperature (relative to material and solidus temperature of member 28).

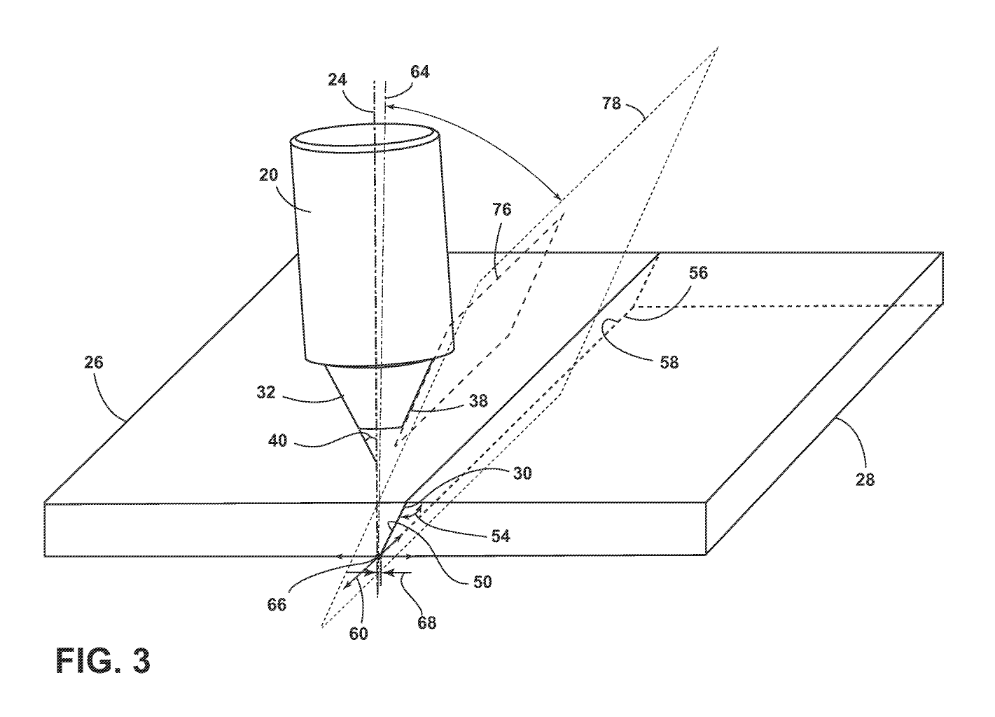

Still referring to FIGS. 2A-2B, member 26 may further define a longitudinal axis 60 and a transverse axis 62 perpendicular to longitudinal axis 60. Member 26 may also define a normal line 64 that is normal to top surface 44, is perpendicular to longitudinal axis 60 and extends through a reference point 66. In the illustrated embodiment, normal line 64, longitudinal axis 60, and reference point 66 may be offset a distance 68 (FIG. 3) from edge 58 in a transverse direction relative to transverse axis 62 (note that Figures are not drawn to scale). In such an embodiment, longitudinal axis 60 is parallel edge 58. In the illustrated embodiment, normal line 64, longitudinal axis 60, and transverse axis 62 serve as a three-dimensional coordinate system 70 with reference point 66 being the origin through which stir tool axis 24 (FIG. 1) extends. Such a coordinate system 70 will be used herein to describe the spatial relationship between stir tool 20 (FIG. 1) and joint interface 30. Moreover, it should be understood that coordinate system 70 may move with stir tool axis 24 (with stir tool axis 24 extending through reference point 66) as stir tool moves along joint interface 30 in the longitudinal direction (along longitudinal axis 60). For clarity, coordinate system 70 is illustrated as being at the front of members 26, 28.

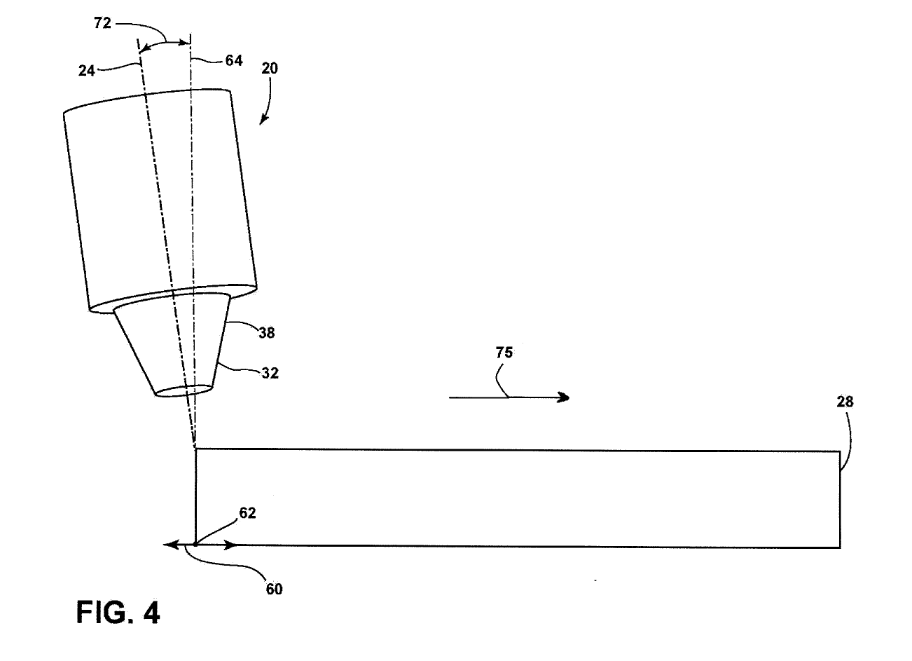

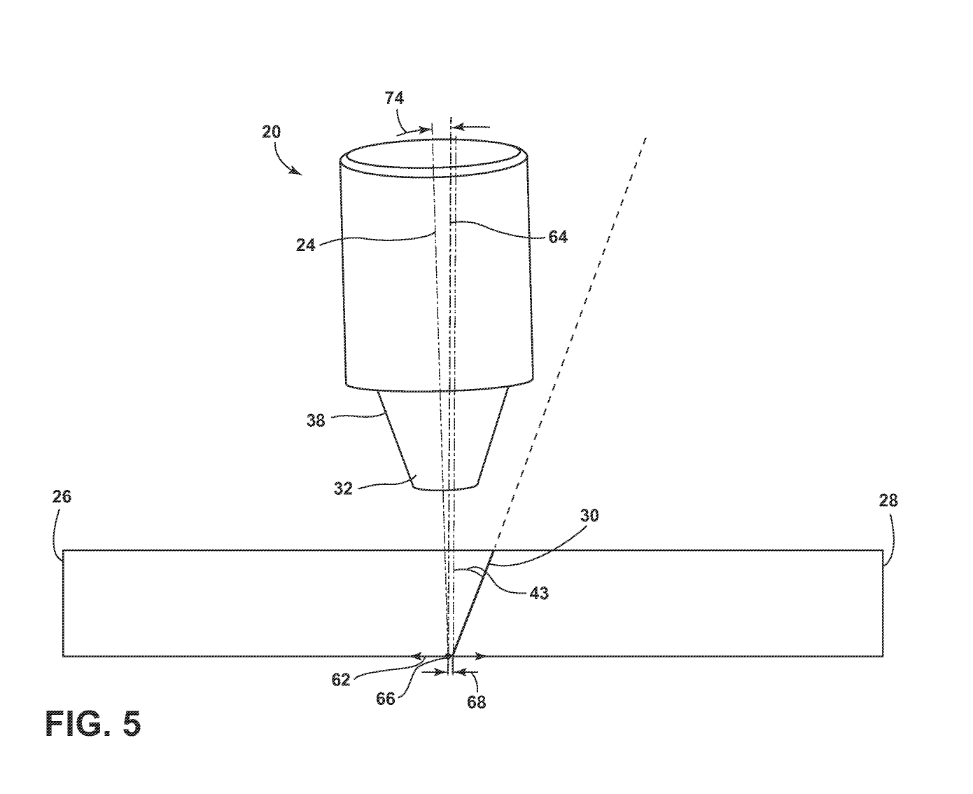

FIG. 3 is an isometric view illustrating stir tool 20 in alignment with the members 26, 28 in accordance with another embodiment of the present teachings. FIG. 4 is a right-side view of stir tool 20 and member 28 illustrating a back tilt angle 72 of stir tool 20. FIG. 5 is a front view of stir tool 20 and members 26, 28 illustrating a side tilt angle 74 of stir tool 20. With reference to FIG. 3, stir tool 20 may be positioned/angled prior to contact with members 26, 28. In an embodiment, pin angle 40 corresponds to angle 54 of faying surface 50 and/or joint interface angle 43 (FIG. 5) such that upon contact between pin 32 and faying surface 50 of member 28, a tangential plane 76 tangent to pin tapered surface 38 is parallel to a portion of faying surface 50 of member 28 being contacted and/or a portion of joint interface 30 being contacted (see plane 78 which in the illustrated embodiment coincides with the plane of faying surface 50 and joint interface 30). In the illustrated embodiment, because faying surface 50 and joint interface 30 are planar (i.e., lie in one plane), plane 76 and plane 78 are parallel. If faying surface 50 and/or joint interface 30 are not planar, then plane 76 and plane 78 may be parallel only at a portion of the faying surface 50 being contacted by pin 32. Such alignment may ensure optimum surface contact between pin tapered surface 38 and faying surface 50 of member 28 and/or joint interface 30. In some embodiments, joint interface angle 43 (FIG. 5) may be approximately equal to pin angle 40. In one embodiment, pin angle 40 may be twelve degrees, and joint interface angle 43 may be twelve degrees.

With simultaneous reference to FIGS. 4-5, in the illustrated embodiment, stir tool 20 is tilted at back tilt angle 72 (FIG. 4) and side tilt angle 74 (FIG. 5). For clarity, stir tool is illustrated as being positioned at the front of members 26, 28; however, one of ordinary skill in the art will understand that stir tool would be plunged into members 26, 28 at other positions. Back tilt angle 72 is measured from normal line 64 about transverse axis 62. In the illustrated embodiment of FIG. 4, the traverse direction 75 of stir tool 20 is to the right. Positioning stir tool 20 at back tilt angle 72 may be desirable to push material of members along joint interface 30 forward in a direction of travel (i.e., traverse direction 75), which in the illustrated embodiment corresponds to longitudinal axis 60 (particularly the softer material will be pushed forward if dissimilar materials are used for members 26, 28). In an embodiment, back tilt angle 72 may be between zero degrees and three degrees. In one particular embodiment, back tilt angle 72 may be three degrees. With reference to FIG. 5, side tilt angle 74 is measured by rotating stir tool axis 24 about longitudinal axis 60 from a position parallel to normal line 64 (best seen in FIG. 4). Positioning stir tool 20 at side tilt angle 74 may be desirable to better align pin 32 of stir tool 20 with joint interface 30 such that there is optimum contact of pin tapered surface 38 of stir tool 20 with joint interface 30 and/or faying surface 50 of member 28 (FIG. 3). In an embodiment, side tilt angle 74 may be between 0.0 degrees and 0.8 degrees. In one particular embodiment, side tilt angle 74 may be 0.21 degrees. In an embodiment, reference point 66 (serving as origin of coordinate system 70) may be offset a distance 68 from edge 58 (FIG. 3) of member 28 in a perpendicular direction relative to longitudinal axis 60. In an embodiment, offset distance 68 may be offset from edge 58 in a transverse direction relative to transverse axis 62. In an embodiment, distance 68 may be approximately half the diameter of pin axial end surface 36. Offsetting the stir tool 20 in this manner may be desirable to better align pin 32 of stir tool 20 with faying surface 50 of member 28 and/or joint interface 30, to reduce wear of the pin, and/or to affect tool-to-joint side load forces. Particularly, it may be desirable to offset the stir tool 20 away from the member that is composed of a harder material (to reduce tool wear). In the illustrated embodiment, member 28 is composed of a harder material (e.g. steel); therefore, reference point 66 lies within member 26. In an embodiment, offset distance 68 may be between 0.0 and 1.5 millimeters. In one particular embodiment, offset distance 68 may be one millimeter. In another embodiment, stir tool 20 may be offset a distance toward the member that is composed of a harder material (to increase tool-to-joint forces).

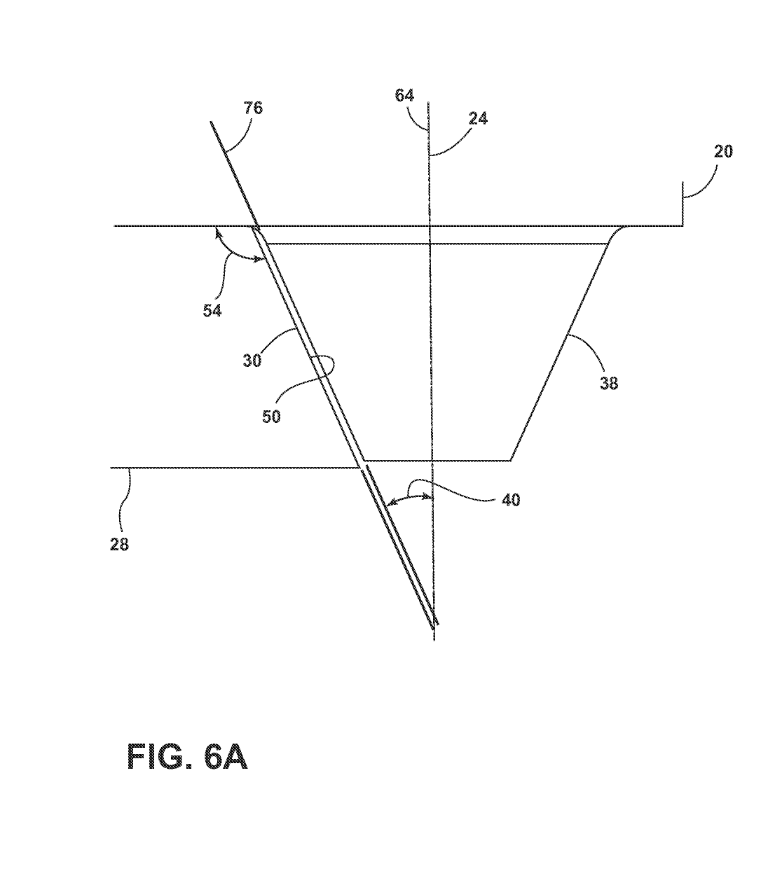

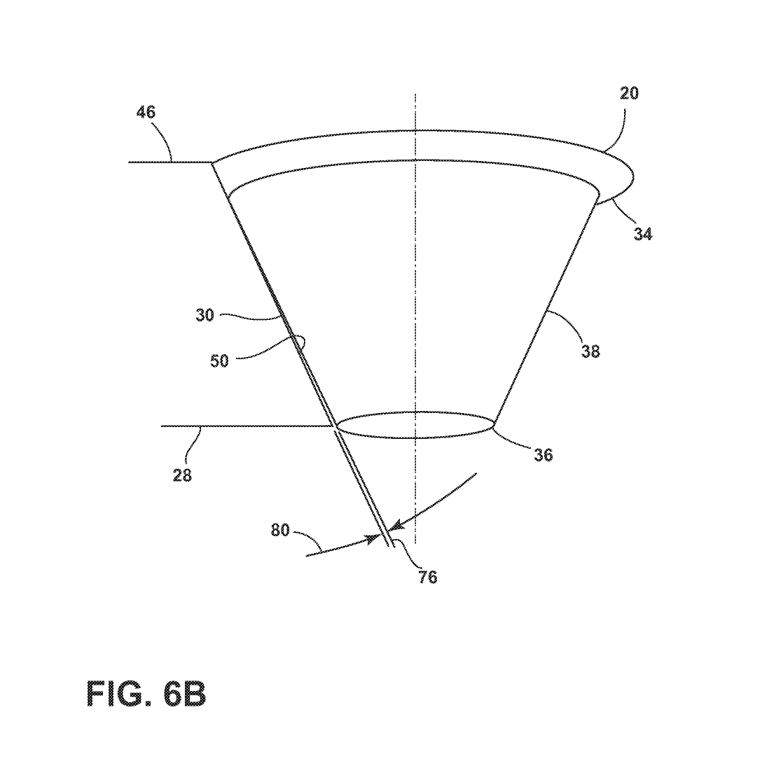

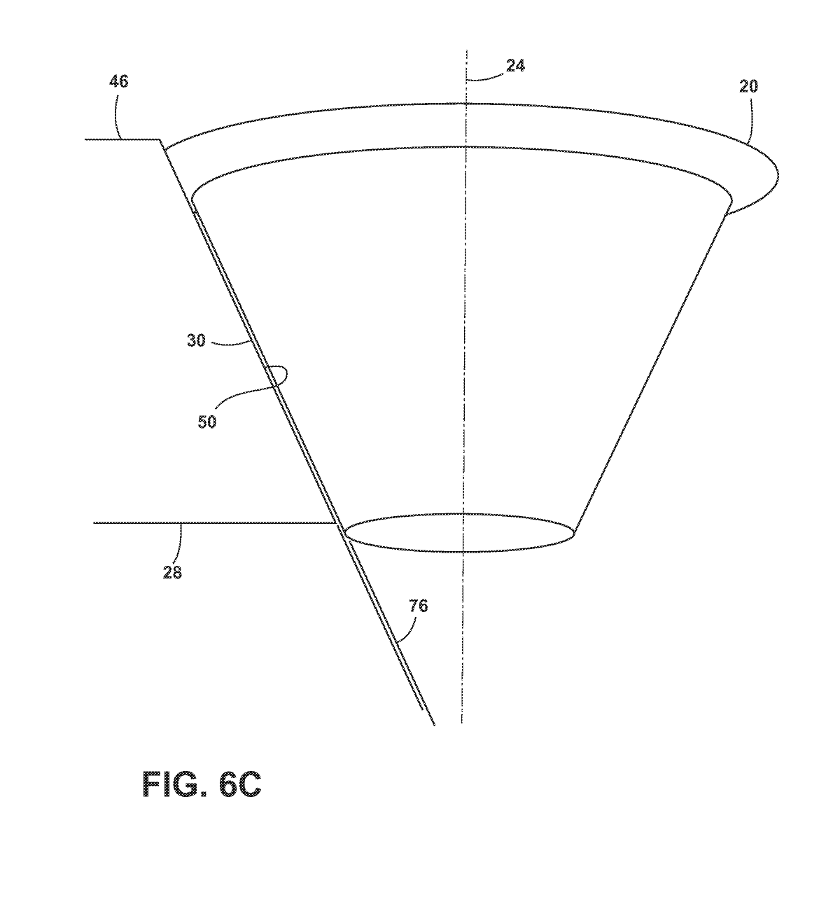

FIGS. 6A-6C show how stir tool 20 aligns with second faying surface and/or joint interface 30 as back tilt angle 72 and side tilt angle 74 are imposed on stir tool 20. For clarity, member 26 is omitted from FIGS. 6A-6C. Furthermore, FIGS. 6A-6C are depicted as back views. FIG. 6A is a close-up schematic view showing the alignment of the friction stir tool 20 relative to the member 28 when the stir tool 20 is in a vertical position (member 26 omitted for clarity). In FIG. 6A, stir tool axis 24 is coaxial with normal line 64. In this instance, pin angle 40 and joint interface angle 43 (FIG. 5) are approximately equal. As such, tangential plane 76 (defined by pin tapered surface 38 and shown in FIG. 3) and joint interface 30 (and/or faying surface 50 of member 28) are parallel to one another.

FIG. 6B is a close-up schematic view showing the alignment of friction stir tool 20 relative to member 28 when the stir tool 20 is in a back-tilted position (member 26 omitted for clarity). As mentioned hereinabove, back tilting of stir tool 20 may be desirable to push the material of members 26, 28 forward as stir tool 20 travels along joint interface 30. However, when stir tool 20 is tilted in such a manner, tangential plane 76 (defined by pin tapered surface 38) and faying surface 50 of member 28 (and/or joint interface 30) are no longer parallel, resulting in a joint misalign angle 80. For example, in FIG. 6B, back tilt angle 72 is 10 degrees, which may result in a joint misalign angle 80 of 0.4 degrees. While joint misalign angle 80 may be relatively small, such misalignment may greatly affect wear on stir tool 20 and the strength of the joint between members 26, 28. Moreover, this misalignment may result in non-optimum contact between pin tapered surface 38 and members 26, 28 and faying surface 50 of member 28 and/or joint interface 30. Such non-uniform contact results in non-uniform mixing of members 26, 28 and non-uniform wear of pin 32 and/or shoulder 34. To correct this misalignment, side tilt angle 74 may be imposed upon stir tool 20.

FIG. 6C is a close-up schematic view showing the alignment of friction stir tool 20 relative to member 28 when stir tool 20 is in a side- and back-tilted position as illustrated in FIGS. 3-5. By imposing side tilt angle 74 (FIG. 5) onto stir tool 20 disposed at back tilt angle 72 (FIG. 4) via angling of stir tool axis 24, tangential plane 76 and faying surface 50 of member 28 are parallel to one another. In one embodiment, side tilt angle 74 can be equal to joint misalign angle 80 (illustrated in FIG. 6B). For example, if back tilt angle 72 is equal to 10 degrees, joint misalign angle 80 is 0.4 degrees. To correct this misalignment, side tilt angle 74 can also be 0.4 degrees.

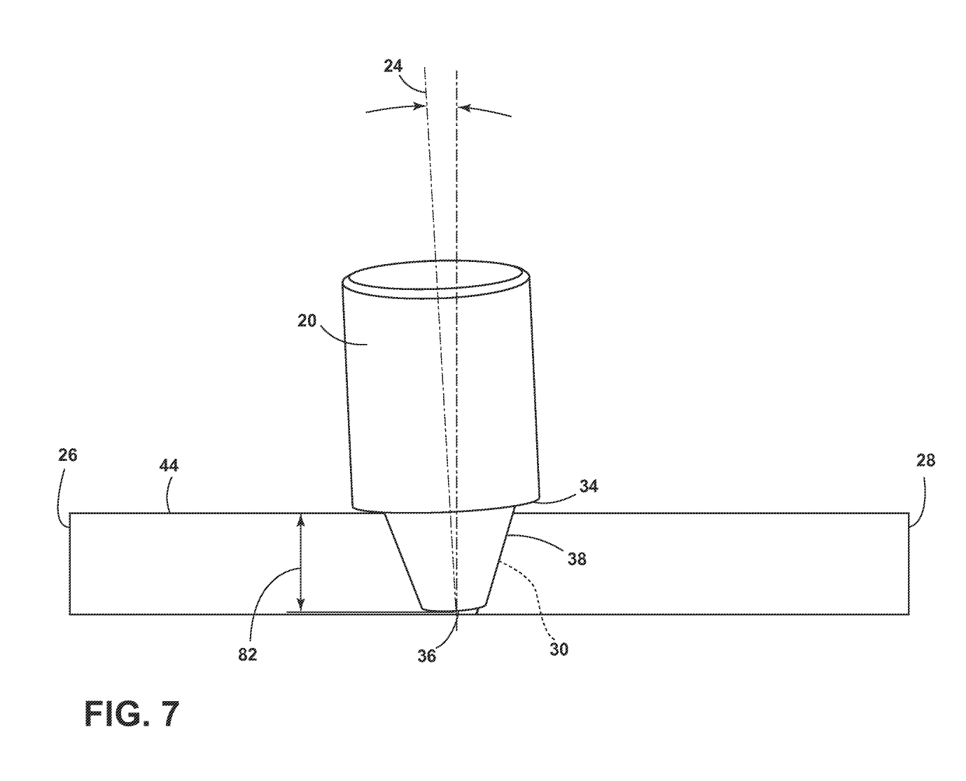

FIG. 7 is a schematic front view illustrating stir tool 20 in a plunge position relative to members 26, 28. In an embodiment, pin axial end surface 36 may be inserted through top surface 44 of member 26 and/or top surface 46 of member 28 and plunge (along stir tool axis 24) to a plunge depth 82 measured from top surface 46 proximate to joint interface 30. Plunge depth 82 may correspond to the point at which shoulder 34 contacts top surface(s) 44, 46 of member(s) 26, 28 and/or a depth of joint interface 30 measured from the surface 46 to edge 58. In an embodiment, plunge depth 82 is calculated so as not to point that pin axial end surface 36 protrudes through bottom surfaces of members 26, 28. Frictional heat increases dramatically once shoulder 34 makes contact with member(s). Therefore, in some embodiments, stir tool 20 may remain in this illustrated plunge position for a period of time (known in the art as “dwelling”) to generate more heat before travelling across joint interface 30 in the traverse direction 75 (FIG. 4).

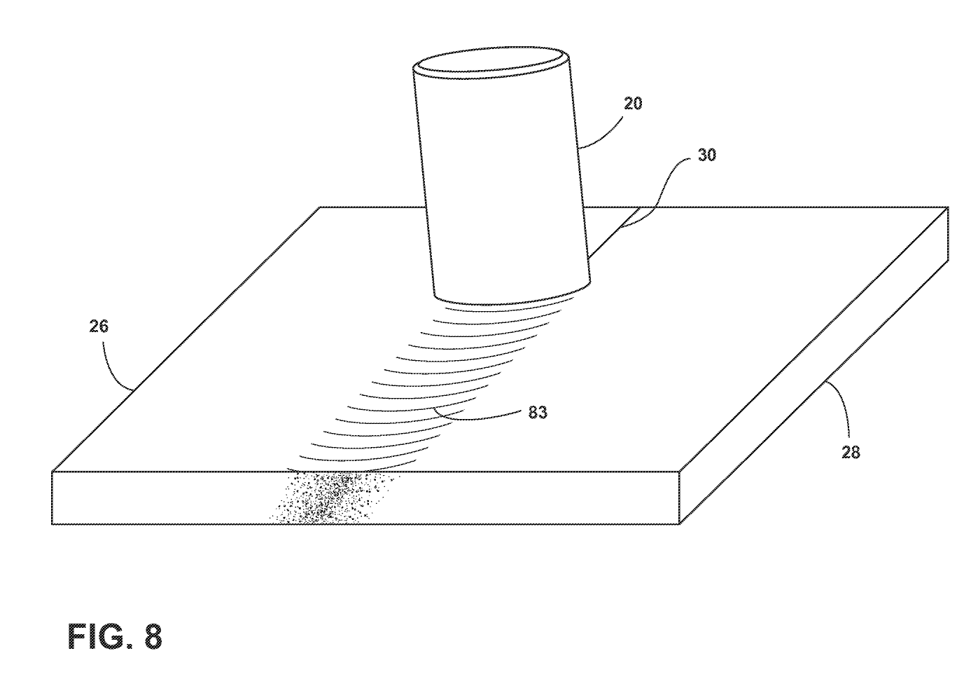

FIG. 8 is a schematic isometric view illustrating stir tool 20 as it travels along joint interface 30. In the illustrated embodiment, stir tool 20 travels in a linear path corresponding to joint interface 30. However, one of ordinary skill in the art will understand that stir tool 20 and/or members 26, 28 can travel in a number of different paths, depending on the shape and orientation of joint interface 30, to form a weld joint 83. Furthermore, while rotating about stir tool axis 24, stir tool 20 may remain linearly stationary and members 26, 28 may move such that stir tool 20 makes contact across joint interface 30.

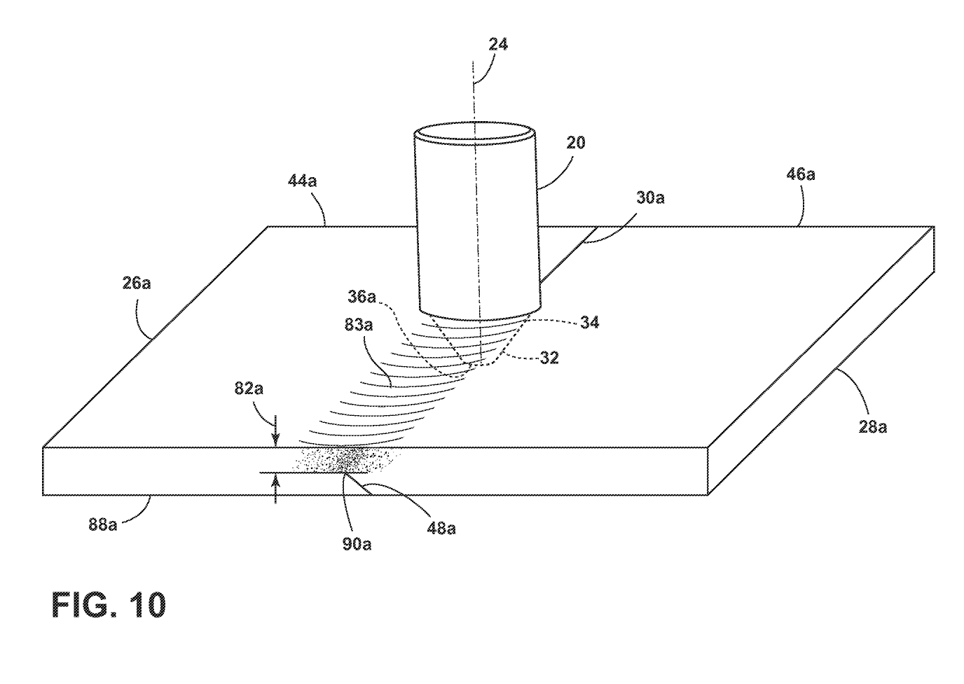

FIG. 9A is an isometric view of members 26a, 28a brought together to form joint interface 30a therebetween in accordance with another embodiment of the present teachings. FIG. 9B is an exploded isometric view of members 26a, 28a of FIG. 9A. In the illustrated embodiment, joint interface 30a is V-shaped along its cross-section. Such a configuration may be desirable if two friction weld joints (top and bottom) are to be utilized in joining members 26a, 28a. For example and without limitation, if pin 32a of stir tool 20a (FIG. 10) is not long enough to reach a plunge depth necessary for creating a strong weld joint between members 26a, 28a (i.e., if members 26a, 28a are thicker than the length of pin 32 shown in FIG. 1), then a first weld joint 83a (FIG. 10) may be created along the top surfaces 44a, 46a of members 26a, 28a, and a second weld joint may be created along bottom surfaces 86a, 88a of members 26a, 28a. Members 26a, 28a may be similar to members 26, 28 of FIGS. 2A-2B except for the faying surfaces 48a, 50a. In the illustrated embodiment, faying surface 48a of member 26a may be generally V-shaped with an edge 56a disposed at an apex 90a and extend from a top surface 44a to edge 56a and from bottom surface 86a to edge 56a. Faying surface 48a may extend at an angle 52a (FIG. 9A) measured between top surface 44a and edge 56a and at an angle 92a (FIG. 9A) measured between bottom surface 86a and edge 56a. In one embodiment, angles 52a, 92a are approximately equal and may be less than ninety degrees. Faying surface 50a of member 28a may correspond in shape to faying surface 48a of member 26a such that faying surfaces 48a, 50a contact one another throughout a depth 95a (FIG. 9A) and length 39a of member 26a to form a sufficient joint interface 30a. In the illustrated embodiment, faying surface 50a of member 28a may be generally V-shaped with an edge 58a disposed at the apex 90a and extend from a top surface 46a to an edge 58a and from bottom surface 88a to edge 58a. Faying surface 50a may extend at an angle 54a (FIG. 9B) measured between top surface 46a and edge 58a and at an angle 94a (FIG. 9B) measured between bottom surface 88a and edge 58a. In one embodiment, angles 54a, 94a are approximately equal and may be greater than ninety degrees.

FIG. 10 is a schematic isometric view illustrating stir tool 20 in a first plunge position relative to members 26a, 28a. In an embodiment, pin axial end surface 36 of stir tool 20 may be inserted through top surface 44a of member 26a and/or top surface 50a of member 28a and plunge (along stir tool axis 24) to plunge depth 82a measured from top surface 44a proximate to joint interface 30a. Plunge depth 82a may correspond to the point at which shoulder 34 contacts top surface(s) 44a, 46a of member(s) 26a, 28a. If pin has no shoulder, plunge depth 82a may also be proximate to apex 90a of faying surface 48a of member 26a. However, one of ordinary skill in the art will understand that plunge depth can be any depth that will result in a weld joint of sufficient strength (depending on the application). Once in the illustrated plunge position, stir tool 20 may travel across joint interface 30a to form a weld joint 83a (as described in more detail hereinabove in connection with the embodiment shown in FIG. 8).

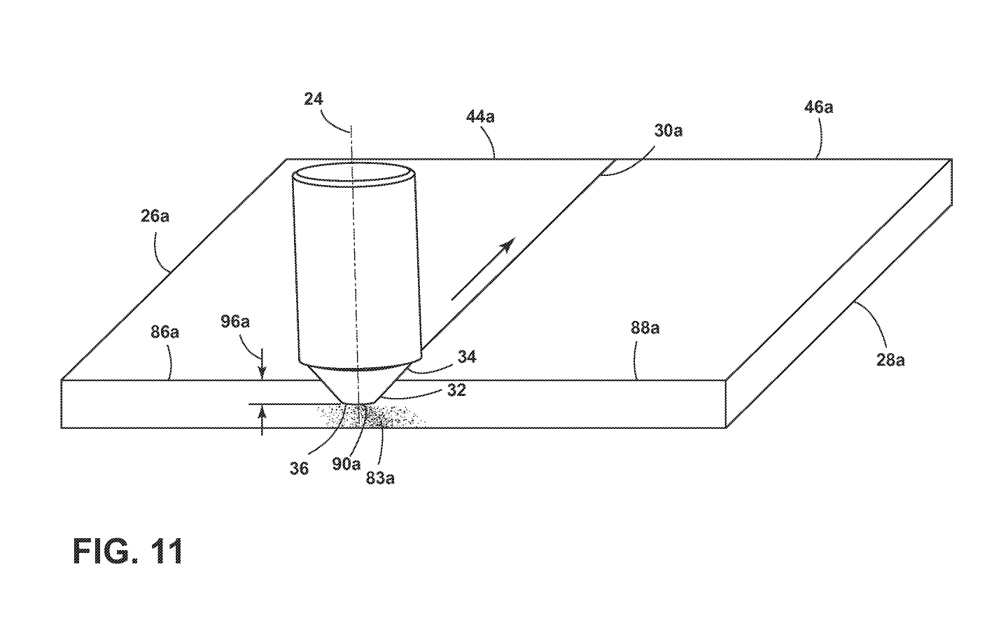

FIG. 11 is a schematic isometric view illustrating stir tool 20 in a second plunge position relative to members 26a, 28a. In one embodiment, members 26a, 28a that are partially joined via the weld joint 83a may be inverted such that bottom surfaces 86a, 88a are in alignment to come into contact with stir tool 20. In an embodiment, pin axial end surface 36 of stir tool 20 may then be inserted through bottom surface 86a of member 26a and plunge (along stir tool axis 24a) to a plunge depth 96a measured from bottom surface 86a proximate to joint interface 30a. Plunge depth 96a may correspond to the point at which shoulder 34 contacts bottom surface(s) 86a, 88a of member(s) 26a, 28a. If pin has no shoulder, plunge depth 96a may also be proximate to apex 90a. However, one of ordinary skill in the art will understand that plunge depth 96a can be any depth that will result in a weld joint of sufficient strength (depending on the application). Once in the illustrated plunge position, stir tool 20 may travel across joint interface 30a to form a second weld joint (as described in more detail hereinabove in connection with the embodiment shown in FIG. 8).

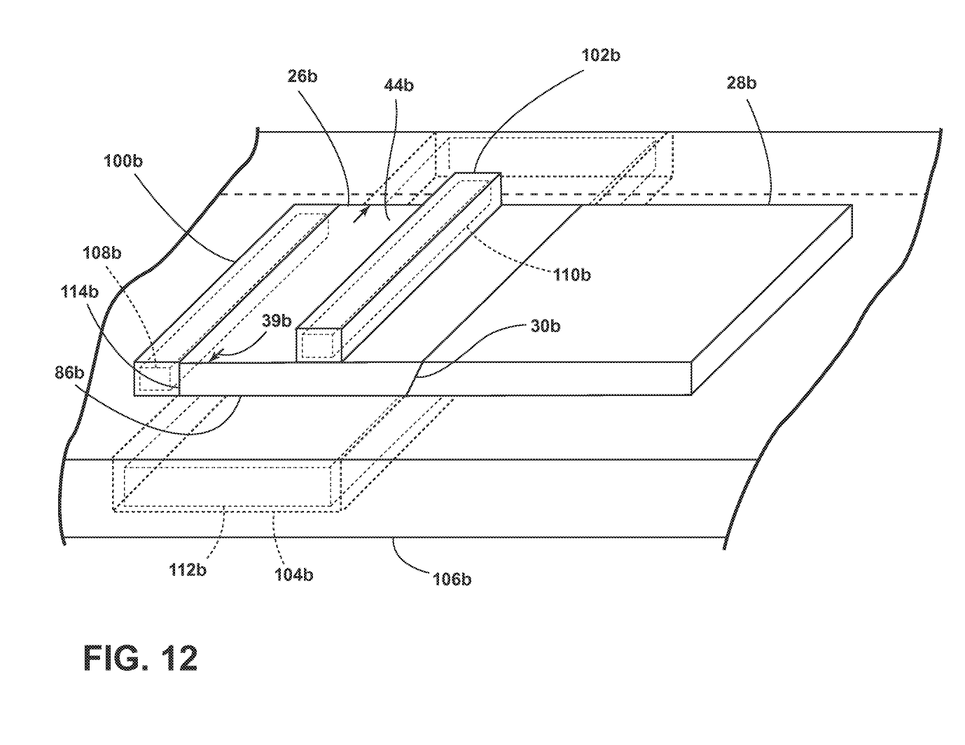

FIG. 12 is a schematic isometric view of cooling members in contact with member in accordance with another embodiment of the present teachings (with stir tool 20 removed for clarity). During friction stir welding, it may be desirable to remove heat from one or both members to be joined. It may be particularly desirable to remove heat only from the member with the lower solidus or melting temperature. Because there must be sufficient heat generated (by friction from stir tool 20) to soften both members along joint interface 30b, the temperature along joint interface 30b must be high enough to soften the material with a higher solidus or melting temperature, which in the illustrated embodiments is member 28b. However, if the difference in solidus or melting temperatures of members is relatively large, then the material with the lower solidus or melting temperature (member 26b in the illustrated embodiments) may liquefy, which is undesirable. Therefore, it may be desirable to remove a substantial amount of heat only from member 26b to prevent the material of member 26b proximate to stir tool 20 from liquefying.

Still referring to FIG. 12, various cooling mechanisms can be employed to remove heat from member 26b, such as cooling bars 100b, 102b and a cooling region 104b within a platen 106b on which members 26b, 28b may be affixed to during welding. Cooling bars 100b, 102b and cooling region 104b may each contain a cavity 108b, 110b, 112b through which coolant may be continuously flowed. In one embodiment, cooling bars 100b, 102b and cooling region 104b may be configured to continuously remove heat from member 26b by, for example and without limitation, positioning cooling bars 100b, 102b and/or cooling region 104b onto member 26b proximate to joint interface 30b such that heat is transferred to cooling bars 100b, 102b and/or cooling region 104b from member 26b. In the illustrated embodiment, cooling bar 100b may be positioned to contact a lateral surface 114b of member 26b and may run the entire length 39b of member 26b, and cooling bar 102b may be positioned to contact top surface 44b of member 26b (and bottom surface 86b upon inversion of members 26b, 28b if two weld joints are desired) and may also run the entire length 39b of member 26b. Also, in the illustrated embodiment, cooling region 104b may be configured to remove heat only from member 26b by being positioned underneath member 26b. While three different mechanisms are herein described, one of ordinary skill in the art will appreciate that only one or two may be utilized in removing heat from member 26b. Furthermore, while cooling bars 100b, 102b and cooling region 104b are illustrated in connection with rectangular members, one of ordinary skill in the art will appreciate that such cooling mechanisms can be utilized on any members regardless of their shape. For example and without limitation, if members are hollow cylinders, a cooling bar may be positioned around a member proximate to the joint interface without interfering with formation of the weld joint(s). Furthermore, a cooling bar may be inserted within the member and make contact with an inner surface thereof.

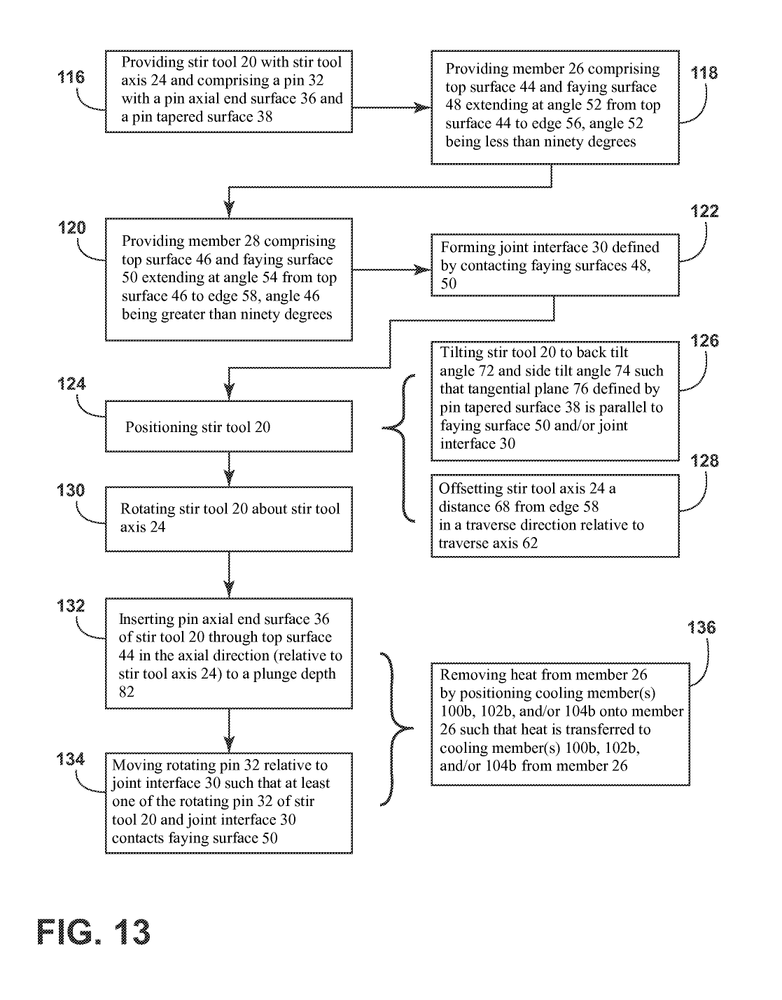

FIG. 13 is a flowchart diagram of a method for friction stir welding members 26, 28 using stir tool 20 in accordance with another embodiment of the present teachings. The method may begin with the process 116 of providing stir tool 20 with stir tool axis 24 and comprising a pin 32 with a pin axial end surface 36 and a pin tapered surface 38. As set forth hereinabove, stir tool 20 may be coupled to a machine configured to rotate stir tool 20 about stir tool axis 24, such as a six-axis CNC machine (e.g., GG1 Series Friction Stir Machine from Transformation Technologies Inc.).

The method may continue with the process 118 of providing member 26 comprising top surface 44 and faying surface 48 extending at angle 52 from top surface 44 to edge 56, angle 52 being less than ninety degrees.

The method may continue with the process 120 of providing member 28 comprising top surface 46 and faying surface 50 extending at angle 54 from top surface 46 to edge 58, angle 46 being greater than ninety degrees.

The method may continue with the process 122 of forming joint interface 30 defined by contacting faying surfaces 48, 50. In an embodiment, process 122 can be accomplished by abutting at least a portion of faying surface 48 of member 26 with at least a portion of faying surface 50 of member 28.

The method may continue with the process 124 of positioning stir tool 20. Process 124 may comprise of several subprocesses. In one embodiment, process 124 may comprise the subprocess 126 of tilting stir tool 20 to back tilt angle 72 and side tilt angle 74 such that tangential plane 76 defined by pin tapered surface 38 is parallel to faying surface 50 and/or joint interface 30. Process 124 may further comprise the subprocess 128 of offsetting stir tool axis 24 a distance 68 from edge 58 in a transverse direction relative to transverse axis 62 or in a perpendicular direction relative to longitudinal axis 60.

The method may continue with the process 130 of rotating stir tool 20 about stir tool axis 24. In an embodiment, stir tool 20 may rotate at a rotational speed between 200 rpm and 400 rpm. In one particular embodiment, stir tool 20 may rotate at 250 rpm. In some embodiments, the rotational speed of stir tool 20 may vary. In other embodiment, the rotational speed of stir tool 20 may be constant.

The method may continue with the process 132 of inserting pin axial end surface 36 of stir tool 20 through top surface 44 in the axial direction (relative to stir tool axis 24) to a plunge depth 82. In another embodiment, pin axial end surface 136 is inserted through top surface 44 and/or top surface 46 (of member 28).

The method may continue with the process 134 of moving rotating pin 32 relative to joint interface 30 such that at least one of the rotating pin tapered surface 38 and joint interface 30 contacts faying surface 50. In one embodiment, stir tool 20 moves across joint interface 30 (in direction 75 shown in FIG. 4) at a speed between ten and fifty millimeters/minute. In one particular embodiment, stir tool 20 moves across joint interface 30 at a speed of forty millimeters/minute. Although processes 124, 126, 128 are described as occurring before processes 130, 132, 134, processes 124, 126, 128 may occur at any time. For example and without limitation, processes 124, 126, 128 may occur after process 132. Furthermore, the position of stir tool 20 may not be constant but instead may vary throughout the process, depending on the shape of the joint interface 30 and the application.

During processes 132, 134, the method may comprise the process 136 of removing heat from member 26 by positioning cooling member(s) 100b, 102b, and/or 104b onto member 26 such that heat is transferred to cooling member(s) 100b, 102b, and/or 104b from member 26. As described hereinabove, process 136 can be accomplished via cooling bars 100b, 102b and cooling region 104b on platen 106b. In one embodiment, coolant is flowed through cooling bars 100b, 102b and cooling region 104b. In one embodiment, coolant may flow from a supply source through bars 100, 102 and region 104 in a closed system. In other embodiments, coolant may flow from three individual supply sources through bars 100, 102 and region 104. Although process 136 is described as occurring simultaneously with processes 132, 134, one of ordinary skill in the art will understand that process 136 can occur any points in time throughout the process.

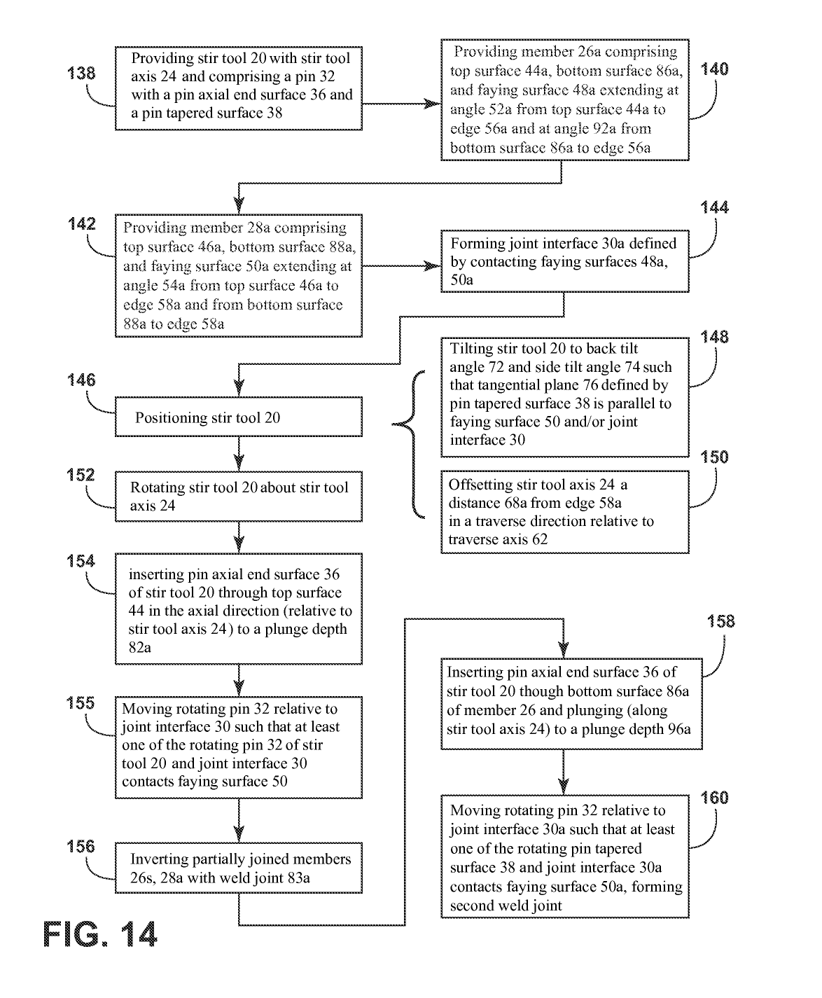

FIG. 14 is a flowchart diagram of a method for friction stir welding members using stir tool 20 in accordance with another embodiment of the present teachings. The method may begin with the process 138 of providing stir tool 20 with stir tool axis 24 and comprising a pin 32 with a pin axial end surface 36 and a pin tapered surface 38.

The method may continue with the process 140 of providing member 26a comprising top surface 44a, bottom surface 86a, and faying surface 48a extending at angle 52a from top surface 44a to edge 56a and at angle 92a from bottom surface 86a to edge 56a. As described hereinabove, angles 52a, 92a may be less than ninety degrees in accordance with some embodiments.

The method may continue with the process 142 of providing member 28a comprising top surface 46a, bottom surface 88a, and faying surface 50a extending at angle 54a from top surface 46a to edge 58a and from bottom surface 88a to edge 58a. As described hereinabove, angles 54a, 94a may be less than ninety degrees in accordance with some embodiments.

The method may continue with the process 144 of forming joint interface 30a defined by contacting faying surfaces 48a, 50a.

The method may continue with the process 146 of positioning stir tool 20. Process 146 may comprise of several subprocesses. In one embodiment, process 146 may comprise the subprocess 148 of tilting stir tool 20 to back tilt angle 72 and to side tilt angle 74 such that tangential plane 76 defined by pin tapered surface 38 is parallel to faying surface 50a and/or joint interface 30a. Process 146 may further comprise the subprocess 150 of offsetting stir tool axis 24 a distance 68 from edge 58a in a transverse direction relative to transverse axis 62 or in a perpendicular direction relative to longitudinal axis 60.

The method may continue with the process 152 of rotating stir tool 20 about stir tool axis 24.

The method may continue with the process 154 of inserting pin axial end surface 36 of stir tool 20 through top surface 44a (and/or top surface 46) in the axial direction (relative to stir tool axis 24) to a first plunge depth 82a.

The method may continue with the process 155 of moving rotating pin 32 relative to joint interface 30a (in direction 75) such that at least one of the rotating pin tapered surface 38 and joint interface 30a contacts faying surface 50a.

The method may continue with the process 156 of inverting partially joined members 26a, 28a with weld joint 83a such that stir tool 20 is in alignment to contact bottom surfaces 86a, 88a. In another embodiment, stir tool 20 is repositioned to contact bottom surfaces 86a, 88a. Moreover, one of ordinary skill in the art will understand that rather than forming joint interface 30a as to be generally V-shaped, joint interface could extend at one angle (as generally shown in connection with the embodiment of FIGS. 2A-5). As such, if two weld joints are desired (top and bottom), stir tool 20 and members 26a, 28a can be repositioned upon formation of second weld joint. In such an embodiment, partially-joined members 26a, 28a may be inverted and rotated one hundred eighty degrees about normal line 64, and the repositioning of stir tool 20 may be complementary of its tilt position upon formation of weld joint 83a. For example, rather than being tilted to the side toward member 26a at a side tilt angle 74 of 0.4 degrees, stir tool 20 may be tilted toward member 28a at a side tilt angle 74 of 0.4 degrees.

The method may continue with the process 158 of inserting pin axial end surface 36 of stir tool 20 through bottom surface 86a (and/or bottom surface 88a) of member 26a and plunging (along stir tool axis 24) to a plunge depth 96a.

The method may continue with the process 160 of moving rotating pin 32 relative to joint interface 30a (in direction 75) such that at least one of the rotating pin tapered surface 38 and joint interface 30a contacts faying surface 50a, forming the second weld joint.

In accordance with some embodiments, the process 136 of removing heat from member 26 described in connection with FIG. 13 may be utilized in the method described in connection with FIG. 14 as well.

Although the methods described herein were described in connection with butt joints, one of ordinary skill in the art will understand that the present teachings could be utilized on any type of joint, such as (for example and without limitation) lap joints. Furthermore, while the methods described herein were described in connection with the welding of dissimilar materials, the present teachings may be utilized in connection with the joining or welding of two or more than two similar materials, whether metal or not.

The foregoing numerous embodiment solve one or more problems known in the art.

Although only certain embodiments have been described above with a certain degree of particularity, those skilled in the art could make numerous alterations to the disclosed embodiments without departing from the scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

What is claimed is:

1. A method of friction stir welding a first member and a second member to form a friction stir weld joint therebetween, the method comprising:
providing a stir tool configured to rotate about and move along a stir tool axis and comprising a pin with a pin axial end surface and a pin tapered surface that extends radially outwardly from the pin axial end surface;
providing the first member, the first member comprising a first member faying surface, the first member further defining a normal line that is normal to the first member top surface, is perpendicular to a longitudinal axis extending through the first member, and extends through a reference point;
providing the second member, the second member comprising a second member faying surface;
forming a first joint interface between the first member and the second member by abutting at least a portion of the first member faying surface with at least a portion of the second member faying surface;
rotating the pin of the stir tool; and
contacting the rotating pin of the stir tool with the second member faying surface, the stir tool axis being disposed at a side tilt angle upon contact, and the side tilt angle being measured by rotating the stir tool axis about the longitudinal axis from a position parallel to the normal line,
wherein the stir tool plasticizes the first member and the second member proximate to the first joint interface thereby forming the friction weld joint.

2. The method of claim 1, wherein contacting the rotating pin of the stir tool with the second member faying surface further comprises:
plunging the pin axial end surface and at least a portion of the pin tapered surface along the stir tool axis into at least one of a first member top surface and a second member top surface to a plunge depth that corresponds to a first joint interface depth, the plunge depth and first joint interface depth being measured from the first member top surface along the stir tool axis and the first joint interface depth being measured from the second member top surface to an edge of the second member faying surface; and
moving the pin tapered surface of the stir tool along the first joint interface by moving at least one of the stir tool and the joint interface.

3. The method of claim 1, wherein the first member faying surface extends at a first angle less than ninety degrees from a first member top surface to a first member edge, and the second member faying surface extends at a second angle greater than ninety degrees from a second member top surface to a second member edge.

4. The method of claim 3, wherein the first member further comprises a first member bottom surface, the first member faying surface extends at a third angle less than ninety degrees from the first member bottom surface to the first member edge, the second member further comprises a second member bottom surface, and the second member faying surface extends at a fourth angle greater than ninety degrees from the second member bottom surface to the second member edge, thereby forming a second joint interface between the first member bottom surface and the first member edge.

5. The method of claim 4, further comprising inserting the pin axial end of the stir tool through at least one of the first member bottom surface and the second member bottom surface proximate to the second joint interface.

6. The method of claim 3, wherein a sum of the first angle and the second angle is approximately equal to 180 degrees.

7. The method of claim 1, wherein upon contact between the pin and the second member faying surface, a tangential plane tangent to the pin tapered surface of the stir tool is parallel to a portion of the second member faying surface being contacted.

8. The method of claim 1, wherein the stir tool axis is disposed at a back tilt angle upon contact between the pin and the second member faying surface, the back tilt angle being measured from the normal line about a transverse axis perpendicular to the longitudinal axis and normal line, the transverse axis, longitudinal axis, and normal line forming a three-dimensional coordinate system.

9. The method of claim 1, wherein the first member and the second member are metal alloys, the first member has a first solidus temperature, and the second member has a second solidus temperature greater than the first solidus temperature.

10. The method of claim 9, wherein the side tilt angle is in a rotational direction toward the first member.

11. The method of claim 1, wherein the second member faying surface extends from a second member top surface to a second member edge, and the stir tool axis is offset a distance from the second member in a transverse direction relative to a transverse axis perpendicular to the longitudinal axis and normal line upon contact between the pin of the stir tool and the second member faying surface.

12. The method of claim 1, further comprising removing heat from one of the first member and second member without removing heat from the other of first member and second member.

13. The method of claim 1, wherein the stir tool further comprises a shoulder adjacent to the pin tapered surface opposite from the pin axial end surface and extending radially outwardly from the pin tapered surface.

14. A method of friction stir welding a first member and a second member to form a friction stir weld joint therebetween, the method comprising:
providing a stir tool configured to rotate about and move along a stir tool axis and comprising a pin with a pin axial end surface and a pin tapered surface that extends radially outwardly at a pin angle from the pin axial end surface, the pin angle being measured from the stir tool axis;
providing the first member, the first member comprising first member faying surface,
providing the second member, the second member comprising a second member top surface and a second member faying surface extending therefrom;
forming a joint interface between the first member and the second member by abutting at least a portion of the first member faying surface with at least a portion of the second member faying surface, the joint interface being disposed at a joint interface angle measured from a line normal to the second member top surface;
rotating the pin of the stir tool; and
contacting the rotating pin of the stir tool with the second member faying surface,
wherein the pin angle of the stir tool and the joint interface angle are approximately equal and the stir tool plasticizes the first member and the second member proximate to the joint interface thereby forming the friction weld joint.

15. The method of claim 14, wherein upon contact between the pin and the second member faying surface, a tangential plane tangent to the pin tapered surface of the stir tool is parallel to a portion of the second member faying surface being contacted.

16. The method of claim 14, wherein the first member faying surface extends at a first angle less than ninety degrees from a first member top surface to a first member edge, and the second member faying surface extends at a second angle greater than ninety degrees from the second member top surface to a second member edge.

17. A method of friction stir welding a first member and a second member to form a friction stir weld joint therebetween, the method comprising:
providing a stir tool configured to rotate about a stir tool axis and comprising a pin;
providing the first member comprising a first member faying surface;
providing the second member comprising a second member faying surface;
forming a joint interface between the first and second members by positioning the first and second members such that at least a portion of the first member faying surface abuts at least a portion of the second member faying surface;
rotating the pin of the stir tool;
moving the rotating pin of the stir tool across the joint interface; and
removing heat from the first member,
wherein the stir tool plasticizes and joins the first member and the second member proximate to the joint interface.

18. The method of claim 17, wherein removing heat from the first member comprises positioning a cooling member onto the first member proximate to the joint interface such that the heat is transferred to the cooling member from the first member.

19. The method of claim 18, wherein the cooling member contacts at least one of a first member top surface, a first member bottom surface and a first member lateral surface.

20. The method of claim 17, wherein heat is removed from the first member without removing heat from the second member.
